(19) United States
(12) Patent Application Publication
(10) Pub. No.: US 2024/0176050 A1
(43) Pub. Date: May 30, 2024

(54) LIQUID LENS

(71) Applicant: CORNING INCORPORATED, CORNING, NY (US)

(72) Inventors: Christian Daniel Gutleben, Ventura, CA (US); Andrew Wesley Johnson, Santa Barbara, CA (US); Nicholas James Pfister, Santa Barbara, CA (US)

(21) Appl. No.: 18/520,819

(22) Filed: Nov. 28, 2023

Related U.S. Application Data
(60) Provisional application No. 63/428,940, filed on Nov. 30, 2022.

(51) Int. Cl. G02B 3/12; G02B 1/04; G02B 7/08; G02B 26/00

(52) U.S. Cl. CPC G02B 3/12; G02B 1/041; G02B 7/08; G02B 26/005

(57) ABSTRACT

A liquid lens includes an intermediate layer having a tapered cavity. First and second outer layers are bonded to top and bottom sides, respectively of the intermediate layer. The liquid lens further includes a chamber that is formed, at least in part by the tapered cavity, and the first and second outer layers. A fluid interface is disposed between first and second fluids in the chamber. The liquid lens further includes first and second electrodes on a top side of the liquid lens. The second electrode is in electrical communication with the first fluid, whereby a position of the fluid interface is based at least in part on voltage applied between the first and second electrodes. The intermediate layer may optionally comprise silicon or glass.

### CROSS-REFERENCE TO RELATED APPLICATIONS

This application claims the benefit of priority under 35 U.S.C. § 119 of U.S. Provisional Application No. 63/428,940 filed Nov. 30, 2022, the content of which is incorporated herein by reference in its entirety.

### BACKGROUND

Liquid lenses generally include two immiscible fluids, one polar and one non-polar, each characterized by a different index of refraction, within a body or housing. The housing incorporates electrodes by which the shape of the liquid lens, and therefore its optical power, may be manipulated based on the principles of electro-wetting.

### SUMMARY

An aspect of the present disclosure is a method of making a liquid lens. The method includes providing a layer of silicon having a first side and a second side that is opposite the first side. A first layer of glass is bonded to the second side of the layer of silicon, and a recess is then etched in the layer of silicon. The recess includes a conical side surface formed in the layer of silicon and a base surface formed by a surface of the first layer of glass. The conical side surface defines first and second circular edges at the first and second sides, respectively, of the layer of silicon. The method includes depositing a first conductive material onto at least a portion of the conical side surface, and on at least a portion of the first side of the layer of silicon. A first dielectric material is deposited onto at least a portion of the first conductive material. At least a portion of the first dielectric material on the conical side surface is covered with an electrically insulating electrowetting material that is configured to provide an electrowetting interface with a conductive liquid. A first electrode is electrically connected to the first conductive material. A second dielectric material is deposited onto at least a portion of the first dielectric material on the first side of the layer of silicon. A second conductive material is deposited onto at least a portion of the second dielectric material. A second electrode is electrically connected to the second conductive material. A second layer of glass is bonded to the first side of the layer of silicon to close off the recess and form a cavity. The method further includes providing conductive and non-conductive liquids in the cavity with an interface between the conductive and non-conductive liquids. The second conductive material is electrically connected to the conductive liquid in the cavity. The first and second electrodes are positioned on the first side of the layer of silicon.

Another aspect of the present disclosure is a method of making a liquid lens. The method includes providing a layer of material having a first (top) side and a second (bottom) side that is opposite the first side. A first (bottom) layer of glass is bonded to the second (bottom) side of the layer of material. A recess is etched in the layer of material. The recess includes a conical side surface formed in the layer of material, and a base surface formed by a surface of the first layer of glass. A first conductive material is deposited onto at least a portion of the conical side surface of the layer of material. An electrically insulating electrowetting material is deposited over at least a portion of the first conductive material, and a first electrode is electrically connected to the first conductive material. A second (top) layer of glass is bonded to the first (top) side of the layer of material to close off the recess and form a cavity. A conductive liquid and a non-conductive liquid are provided in the cavity with an interface between the conductive and non-conductive liquids. A second conductive material is electrically connected to a second electrode and to the conductive liquid in the cavity, whereby a voltage can be applied to the first and second electrodes to influence a shape of the interface. The layer of material may optionally comprise a layer of silicon, and the first and second electrodes are optionally positioned on the first side of the layer of silicon.

Another aspect of the present disclosure is a method of making a liquid lens having top-only electrical connections. The method includes providing a layer of material having a top side and a bottom side that is opposite to the top side. The layer of material has a recess including a conical side surface. The conical side surface may define first and second circular edges forming top and bottom openings at the top and bottom sides, respectively of the layer of material. The method includes depositing a first conductive material on at least a portion of the conical side surface and on at least a portion of the top side of the layer of material. A first dielectric material is deposited onto at least a portion of the first conductive material. At least a portion of the first dielectric material on the conical side surface is covered with an electrowetting material that is configured to provide an electrowetting interface with a conductive liquid. A first electrode is electrically connected to the first conductive material. A second dielectric material is deposited onto at least a portion of the first dielectric material on the top side of the layer of material. The method further includes depositing a second conductive material onto at least a portion of the second dielectric material. A second electrode is electrically connected to the second conductive material. A bottom layer of glass is bonded to the bottom side of the layer of material to close off the bottom opening of the recess. A top layer of glass is bonded to the top side of the layer of material to close off the top opening of the recess to form a cavity. At least a portion of the second conductive material is electrically connected to the cavity. Conductive and non-conductive liquids are provided in the cavity with an interface between the conductive and non-conductive liquids. The second conductive material is electrically connected to the conductive liquid in the cavity. The first and second electrodes are positioned on the top side of the layer of material. The method may optionally include bonding a temporary bottom layer onto the bottom side of the layer of material to close off the bottom opening, and first conductive material may then be deposited onto a portion of the temporary bottom layer extending across the bottom opening. The temporary bottom layer may be removed prior to bonding the bottom layer of glass to the bottom side of the layer of material.

Another aspect of the present disclosure is a liquid lens including an intermediate layer having a tapered cavity with a wide end and a narrow end. A first outer layer is bonded to a top side of the intermediate layer at the wide end of the tapered cavity. A second outer layer is bonded to a bottom side of the intermediate layer at the narrow end of the tapered cavity. The liquid lens further includes a chamber that is formed, at least in part, by the tapered cavity, the first outer layer, and the second outer layer. First and second fluids are contained in the chamber, with a fluid interface between the first fluid and second fluid. The liquid lens further includes one or more first electrodes that are insulated from the first and second fluids. The one or more first electrodes include a first layer of conductive material disposed on at least a portion of the tapered cavity and on at least a portion of the top side of the intermediate layer. Each of the one or more first electrodes includes a conductive pad on the top side of the intermediate layer for connection to a voltage source. The liquid lens further includes a second electrode in electrical communication with the first fluid. The second electrode includes a second layer of conductive material disposed on the top side of the intermediate layer. The second electrode further includes a conductive pad on the top side of the intermediate layer for connection to a voltage source. A position of the fluid interface is based, at least in part, on voltage applied between the first and second electrodes. The intermediate layer may optionally comprise silicon or glass.

Another aspect of the present disclosure is a liquid lens including a body. The body includes an intermediate layer having a bore therethrough. The body further includes a first layer disposed on a first side of the intermediate layer, and a second layer disposed on a second side of the intermediate layer that is opposite the first side of the intermediate layer. The body has a cavity that is defined, at least in part, by the bore through the intermediate layer. The liquid lens includes a conductive first liquid disposed in the cavity, a non-conductive second liquid disposed in the cavity, and an interface between the first and second liquids. The liquid lens further includes a first conductive material disposed on at least a portion of the bore, and a dielectric material covering at least a portion of the first conductive material, whereby the first and second liquids do not directly contact the first conductive material due to the dielectric material. The liquid lens further includes a second conductive material disposed on at least a portion of the first side of the intermediate layer in electrical communication with the first liquid in the cavity. The first conductive material is electrically connected to an anode that is disposed on the second side of the intermediate layer. The second conductive material is electrically connected to a cathode that is disposed on the second side of the intermediate layer by a conductive via extending through the intermediate layer. The interface has a shape that is influenced by a voltage differential between the anode and the cathode.

Another aspect of the present disclosure is a liquid lens including a body having an intermediate layer with a bore therethrough. The body further includes a first layer disposed on a first side of the intermediate layer, and a second layer disposed on a second side of the intermediate layer that is opposite the first side of the intermediate layer. The body has a cavity defined, at least in part, by the bore through the intermediate layer. The liquid lens further includes a conductive first liquid disposed in the cavity, a non-conductive second liquid disposed in the cavity, and an interface between the first and second liquids. A first conductive material forms a first electrical contact on a second side of the body. A second conductive material is disposed on at least a portion of the first side of the intermediate layer in electrical communication with the first liquid in the cavity. The second conductive material is electrically connected to a second electrical contact on the second side of the body by a conductive via extending at least partially through the intermediate layer. The interface has a shape that is influenced by a voltage differential between the first electrical contact and the second electrical contact.

Another aspect of the present disclosure is a method of making a liquid lens. The method includes forming a bore through a non-conductive wafer having first and second opposite sides. At least one hole through the non-conductive wafer is formed, and the at least one hole is at least partially filled with a conductive via material. The method further includes depositing a first conductive material on at least a first portion of the bore, and depositing a dielectric material on at least a portion of the first conductive material. The method further includes depositing a second conductive material on at least a portion of the first side of the non-conductive wafer, and the second conductive material is electrically connected to the conductive via material. The method further includes bonding a first layer of material to the first side of the non-conductive wafer, and bonding a second layer of material to the second side of the non-conductive wafer. A conductive first liquid is disposed in a cavity formed, at least in part, by the bore through the non-conductive wafer, the first layer, and the second layer. A non-conductive second liquid is disposed in the cavity, whereby an interface is formed between the first and second liquids. A first electrical contact is formed, wherein the first electrical contact is electrically connected to the first conductive material deposited on the bore. The method further includes forming a second electrical contact that is electrically connected to the conductive via material. The first and second electrical contacts are disposed on a second side of the liquid lens adjacent to the second side of the non-conductive wafer.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a partially schematic top plan view of a liquid lens according to an aspect of the present disclosure:

FIG. 2 is a partially schematic cross-sectional view of the liquid lens of FIG. 1 taken along the line I-I: FIG. 1;

FIG. 3 is a partially schematic, fragmentary enlarged view of a portion of the liquid lens of FIG. 2:

FIG. 4A is a partially schematic top plan view showing components during a process of fabricating a liquid lens according to an aspect of the present disclosure:

FIG. 4B is a partially schematic side elevational view corresponding to FIG. 4A:

FIG. 4C is a flow chart showing a first portion of a process corresponding to FIGS. 4A and 4B:

FIG. 4D is a flow chart showing a second portion of a process corresponding to FIGS. 4A and 4B:

FIG. 5 is a top plan view of a partially fabricated liquid lens according to an aspect of the present disclosure:

FIG. 6 is a cross-sectional view of the partially fabricated liquid lens of FIG. 5 taken along the line VI-VI:

FIG. 7 is an enlarged cross-sectional view of a portion of the liquid lens of FIG. 6:

FIG. 8 is a top plan view of a partially fabricated liquid lens according to an aspect of the present disclosure:

FIG. 9 is a cross-sectional view of the partially fabricated liquid lens of FIG. 8 taken along the line IX-IX:

FIG. 10 is a partially fragmentary enlarged view of a portion of the partially fabricated liquid lens of FIG. 9:

FIG. 11 is a top plan view of a partially fabricated liquid lens according to an aspect of the present disclosure:

FIG. 12 is a cross-sectional view of the partially fabricated liquid lens of FIG. 11 taken along the line XII-XII:

FIG. 13 is a top plan view of a partially fabricated liquid lens according to an aspect of the present disclosure:

FIG. 14 is a cross-sectional view of the partially assembled liquid lens of FIG. 13 taken along the line XIV-XIV:

FIG. 15 is a partially fragmentary enlarged view of a portion of the liquid lens of FIG. 14;

FIG. 16 is a top plan view of a partially fabricated liquid lens according to an aspect of the present disclosure:

FIG. 17 is a cross-sectional view of the liquid lens of FIG. 16 taken along the line XVII-XVII:

FIG. 18 is a partially fragmentary enlarged view of a portion of the liquid lens of FIG. 17:

FIG. 19 is a top plan view of a partially fabricated liquid lens according to an aspect of the present disclosure:

FIG. 20 is a partially fragmentary enlarged view of a portion of the liquid lens of FIG. 19;

FIG. 21A is a partially schematic plan view of components during a process of fabricating a liquid lens according to another aspect of the present disclosure;

FIG. 21B is a partially schematic side elevational view showing the components of FIG. 21A:

FIG. 21C is a flow chart showing a first portion of a process corresponding to FIGS. 21A and 21B:

FIG. 21D is a flow chart showing a second portion of a process corresponding to FIGS. 21A and 21B:

FIG. 22 is a top plan view of a partially fabricated liquid lens according to another aspect of the present disclosure:

FIG. 23 is a cross-sectional view of the partially fabricated liquid lens of FIG. 22 taken along the line XXIII-XXIII:

FIG. 24 is a partially fragmentary enlarged view of a portion of the liquid lens of FIG. 23:

FIG. 25 is a top plan view of a partially fabricated liquid lens according to an aspect of the present disclosure:

FIG. 26 is a side elevational view of the liquid lens of FIG. 25 taken along the line XXVI-XXVI:

FIG. 27 is a partially fragmentary enlarged view of a portion of the liquid lens of FIG. 26:

FIG. 28 is a flow chart showing a process of fabricating a subassembly for a liquid lens according to an aspect of the present disclosure:

FIG. 29A is a partially schematic side elevational view of a subassembly for liquid lenses utilized in the process of FIG. 28:

FIG. 29B is a partially schematic side elevational view of a subassembly for liquid lenses utilized in the process of FIG. 28:

FIG. 29C is a partially schematic side elevational view of a subassembly for liquid lenses utilized in the process of FIG. 28:

FIG. 29D is a partially schematic side elevational view of a subassembly for liquid lenses utilized in the process of FIG. 28:

FIG. 29E is a partially schematic side elevational view of a subassembly for liquid lenses utilized in the process of FIG. 28:

FIG. 30 is a partially schematic view of a liquid lens according to an aspect of the present disclosure:

FIG. 31 is a partially schematic view of the liquid lens of FIG. 30; and

FIG. 32 is a partially schematic view of the liquid lens of FIG. 31.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

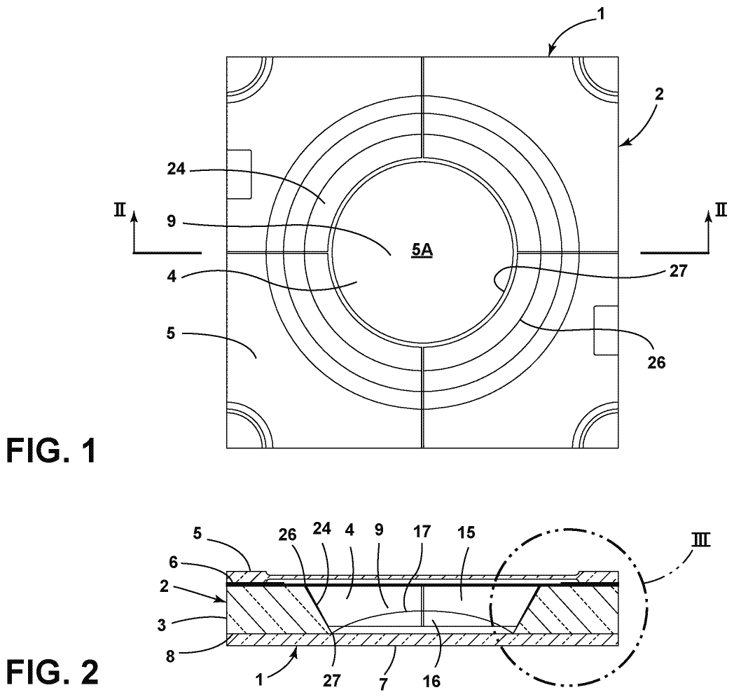

For purposes of description herein the terms “upper,” “lower,” “right,” “left,” “rear,” “front,” “vertical,” “horizontal,” and derivatives thereof are not limiting and shall relate to the device/disclosure as oriented in FIGS. 1 and 2. However, it is to be understood that the disclosure may assume various alternative orientations and step sequences, except where expressly specified to the contrary. It is also to be understood that the specific disclosures illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

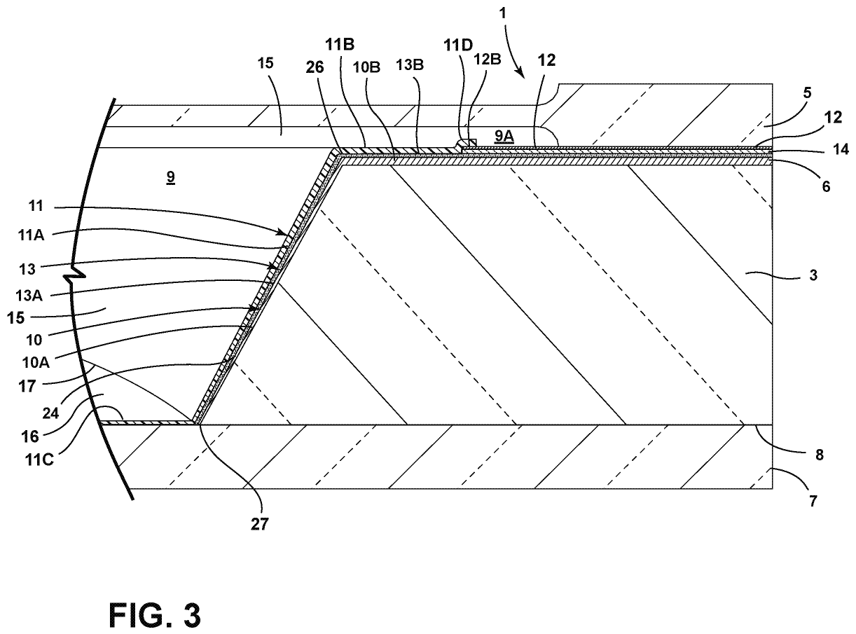

With reference to FIGS. 1 and 2, a liquid lens 1 according to an aspect of the present disclosure includes a body 2. The body 2 may include an intermediate layer 3 that is disposed between layers 5 and 7. Liquid lens 1 may include first and second conductive materials 10 and 12, respectively, wherein portions of conductive materials 10 and 12 are disposed on first side 6 of intermediate layer 3. A bore 4 extends through the intermediate layer 3. The bore 4 may have a conical side surface 24 that forms a circular edge 26 at the intersection of conical surface 24 and first side 6 of intermediate later 3, and a circular edge 27 at the intersection of conical surface 24 and second side 8 of intermediate layer 3. The first (top) layer 5 is disposed on first (top) side 6 of the intermediate layer 3, and second (bottom) layer 7 is disposed on a second (bottom) side 8 of the intermediate layer 3. The liquid lens includes a cavity 9 that may be defined, at least in part, by the bore 4 through the intermediate layer 3, the first layer 5, and the second layer 7. Layer 5 may include a central portion 5A and a peripheral portion 5B that is thicker than central portion 5A (FIG. 3). Edge portion 5B may be sealingly bonded to a peripheral portion 12A of a conductive layer 12, and central portion 5A may be spaced apart (raised) relative to layer 12 to form an edge portion 9A of cavity 9.

The liquid lens 1 may include a conductive first liquid 15 disposed in the cavity 9, and non-conductive second liquid 16 that is also disposed in the cavity 9, with an interface 17 between the first and second liquids 15 and 16, respectively.

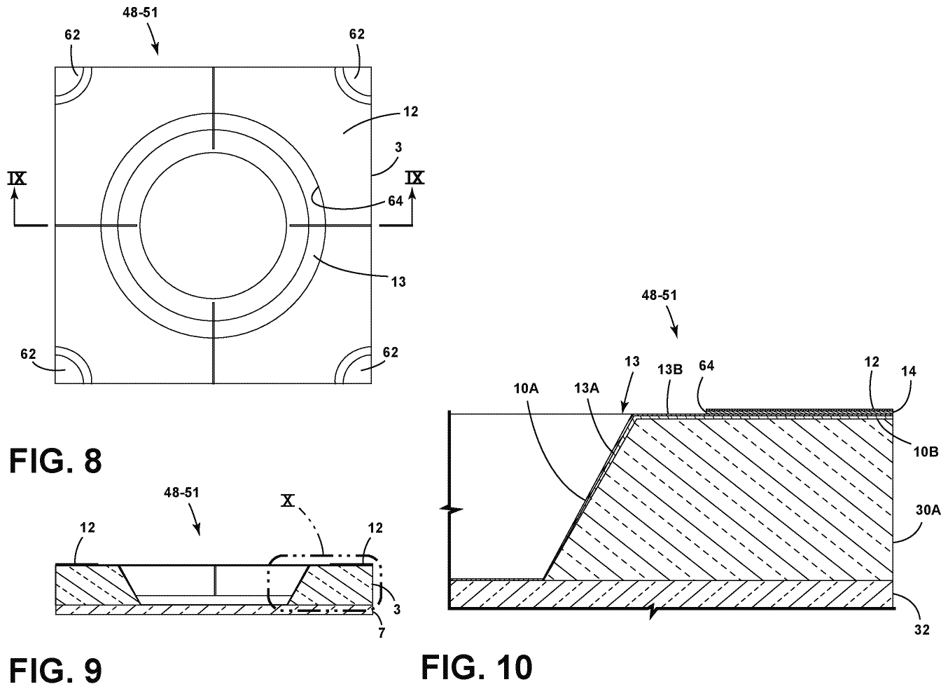

With further reference to FIG. 3, a first conductive material 10 (e.g. metal) includes a first portion 10A that is disposed on conical side surface 24, and a second portion 10B that is disposed on first side 6 of intermediate layer 3. As discussed in more detail below, the portions 10A and 10B of conductive material 10 may be deposited on intermediate layer 3 to form a conductive layer extending across at least a portion of first side 6 and side wall 24 of bore 4 of intermediate layer 3. A first dielectric material 13 includes a first portion 13A that is disposed on first portion 10A of first conductive material 10, and a second portion 13B that is disposed on portion 10B of first conductive material 10. A non-conductive wetting (electrowetting) material 11 (e.g. parylene) may include a first portion 11A that is disposed on first portion 13A of first dielectric 13, and a second portion 11B that is disposed on second portion 13B of first dielectric 13. An edge portion 11D of layer 11 may (optionally) overlap an edge portion 12B of a second conductive material 12, or gap “6” (FIG. 15) may be formed whereby a portion of layer 13 is not covered by layer 11 or layer 12. Alternatively, the edge of layer 11 may abut an edge of second conductive material 12 and/or abut an edge of a second dielectric layer 14 rather than overlapping at 11D. It will be understood that any or all of the liquid lenses described herein in connection with FIGS. 1-32 may optionally include any of an overlapping portion 11D (FIG. 3), and/or a gap “G” (FIG. 15), and/or the edge of layer 11 may abut an edge of layer 12 and/or an edge layer 14.

As discussed in more detail below; the first dielectric layer 13 may be utilized to improve adhesion of electrowetting layer 11 and/or may act as a diffusion barrier. As also discussed below; the first dielectric material 13 may provide an etch stop for a second dielectric material 14 during fabrication. The first dielectric material 13 may comprise virtually any suitable material. One example is a metal oxide, such as aluminum oxide Al₂O₃. Second conductive material 12 (e.g. metal) may be disposed on second dielectric material 14, whereby a portion of the second conductive material 12 is in electrical communication with first liquid 15 in edge portion 9A of cavity 9. In general, first and second conductive materials 10 and 12 may both have the same material composition, or they may comprise different types of material. Typically, second side 8 of intermediate layer 3 is bonded directly to second layer 7, and liquid lens 1 does not typically include conductive material disposed between intermediate layer 3 and second layer 7.

Referring again to FIGS. 1 and 2, the interface 17 formed by liquids 15 and 16 has a shape that is influenced by a voltage differential between the first conductive material 10 and the second conductive material 12. In particular, the first conductive material 12 is exposed to first liquid 15 in a gap region 9A of cavity 9, whereas first conductive material 10 is electrically insulated from first liquid 15 by electrowetting layer 11 and/or first dielectric material 13. In use, light passes through a central portion 5A of the liquid lens, and the shape of the interface 17 may be controlled by controlling a voltage between first conductive material 10) and second conductive material 12. The first layer 5 and second layer 7 may comprise glass (e.g. transparent or clear glass). The intermediate layer 3 may also comprise glass. Alternatively, the intermediate layer 3 may comprise silicon. If the intermediate layer 3 comprises glass, the bore 4 may be formed by pressing or other suitable processes that are generally known in the art. Alternatively, as discussed in more detail below, if the intermediate layer 3 comprises a different material such as silicon, the bore 4 may be formed utilizing an etching process.

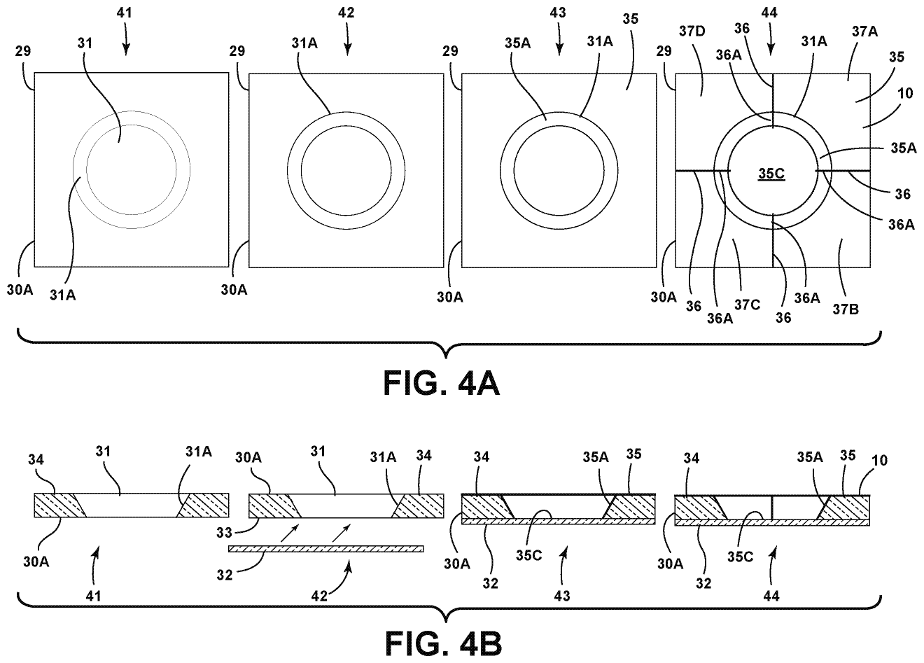

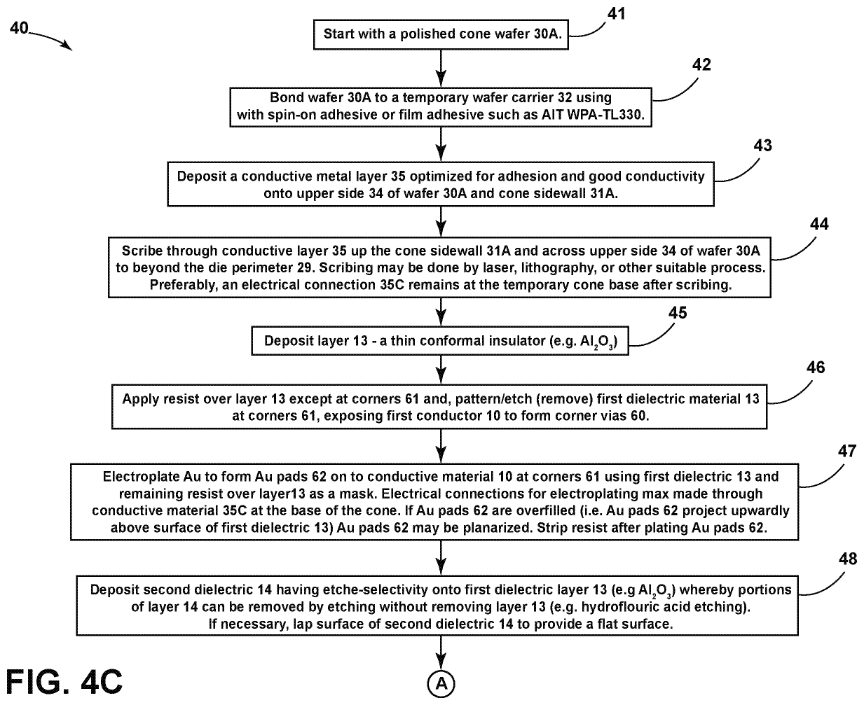

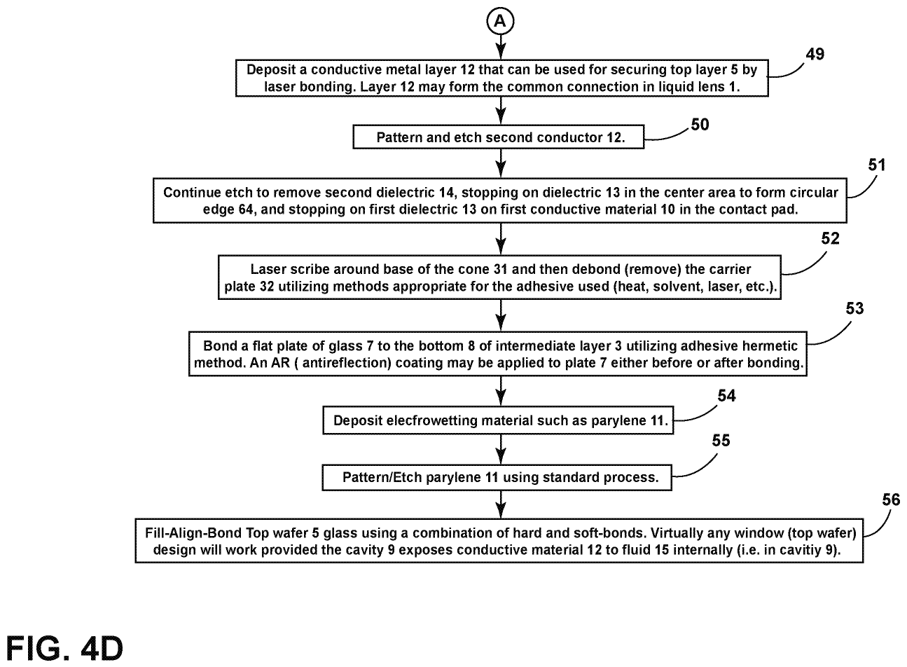

FIGS. 4A-18 show various aspects of components and processes that may be utilized to make liquid lens 1, and FIG. 4C is a flow chart showing a process 40 that includes steps 41-57 that generally correspond to the components and processes shown in FIGS. 4A-18.

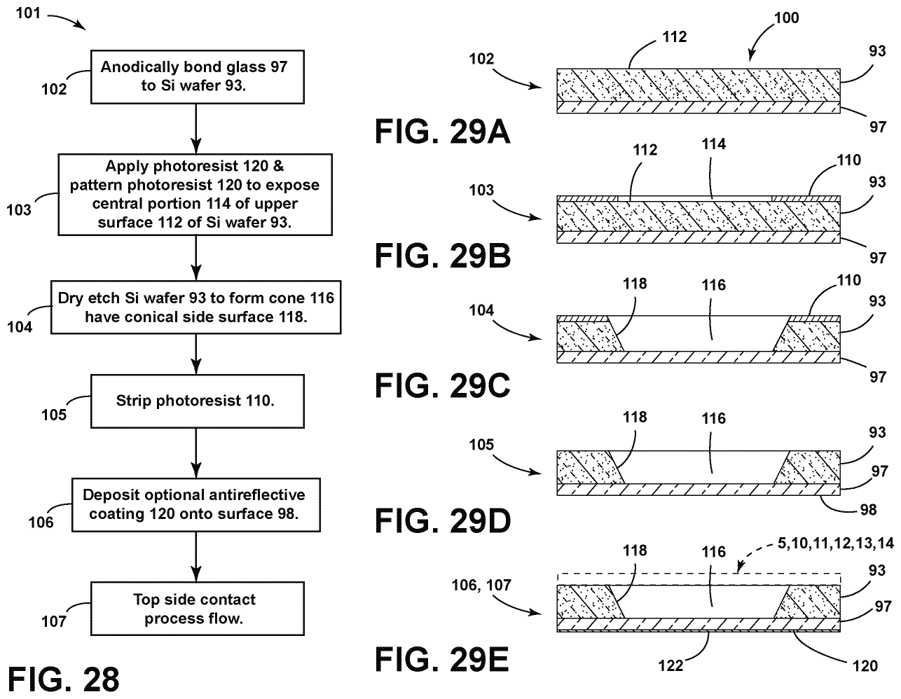

With further reference to FIGS. 4A and 4B, steps 41-44 of process 40 for forming a liquid lens 1 may utilize a wafer 30A (step 41) having a cone-shaped bore or aperture 31. FIG. 4A shows a top plan view of the components during fabrication, and FIG. 4B comprises side elevational views of the components during fabrication. Cone-shaped bore or aperture 31 may include a conical sidewall surface 31A. Wafer 30A may comprise glass or other suitable material such as silicon. Wafer 30A may correspond to intermediate layer 3 of FIGS. 1-3, and cone-shaped aperture 31 may correspond to the bore 4 described in more detail above in connection with FIGS. 1-3. If the wafer 30A comprises glass, the aperture 31 may be formed by pressing or other suitable process. Alternatively, if the wafer 30 comprises silicon, the aperture 31 may be formed by etching or other suitable process as discussed in more detail below in connection with FIGS. 28 and 29A-29E.

In a second step 42, a temporary wafer carrier 32 is bonded to a lower side surface 3 of wafer 30A utilizing a suitable adhesive such as spin-on adhesive or film adhesive (e.g. AIT WPA-TL330). Next, at step 43, a conductive layer 35 is deposited on upper side 34 of wafer 30A. The conductive layer 35 may comprise metal (e.g. first conductive material 10) or other suitable material. The material of conductive layer 35 may be selected to optimize adhesion while also providing high conductivity. A portion 35A of the conductive layer 35 is deposited on a sidewall 31A of the cone-shaped aperture 31.

During step 44, the conductive layer 35 is scribed to form gaps 36 adjacent upper side 34 of and gaps 36A extending adjacent the conical surface 31A. The scribe lines/gaps 36 and 36A form electrically isolated regions 37A-37D of conductive layer 35. The scribing may be done by laser, lithography or other suitable process. The regions 37A-37D may be temporarily interconnected electrically by a portion 35C of conductive layer 35 that is disposed on an upper side of temporary wafer carrier 32. It will be understood that regions 37A-37D generally correspond to first conductive material 10 of FIGS. 1-3.

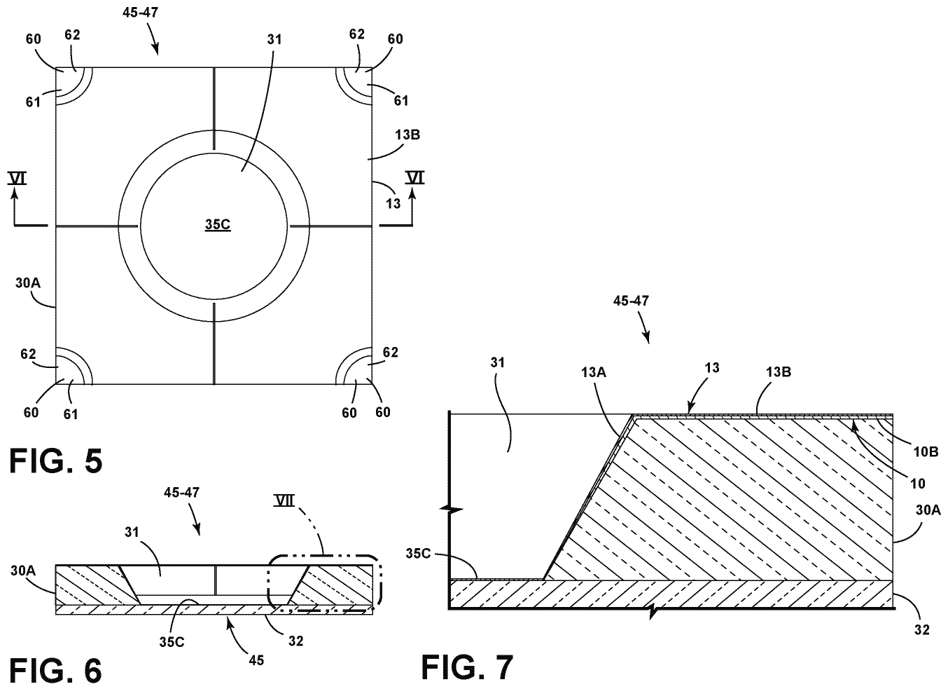

With further reference to FIGS. 5-7, during step 45 (see also FIG. 4C) first dielectric material 13 is deposited onto the layer 35 of first conductive material 10. The first dielectric 13 may comprise Al₂O₃ or other thin conformal electrically insulating material. At step 46 a resist (not shown) is applied over first dielectric layer 13 except at corners 61 and the first dielectric material 13 is removed at corners 61 to expose first conductor 10 to thereby form corner vias 60. At step 47, a conductive material such as gold (Au) is electroplated onto the exposed first conductive material 10 at corners 61 to form conductive (Au) pads 62. During the electroplating process, the first dielectric 13 and remaining resist on layer 13 is used as a mask. Electrical connections for the electric plating process may be made through conductive material 35C at the base of the cone aperture 31. If the conductive pads 62 are overfilled (e.g. the conductive pads 62 project upwardly beyond the surface of the first dielectric 13), the conductive pads 62 may be planerized to bring the surface of the conductive pads 62 to the same level as the surface of first dielectric material 13. Conductive pads 62 may comprise any suitable conductive material (e.g. silver, copper, gold, aluminum, zinc, or brass), or combinations or mixtures of conductive materials.

With further reference to FIGS. 8-10, during step 48 (see also FIG. 4C) second dielectric material 14 is deposited onto the first dielectric layer 13. Second dielectric material 14 may have etch-selectivity whereby portions of layer 14 can be removed by etching without removing layer 13. For example, second dielectric 14 may comprise SiO₂, the first dielectric layer 13 may comprise Al₂O₃, and a hydrochloric etching process may be utilized to selectively remove second dielectric 14.

At step 49, a second conductive (e.g. metal) layer 12 is deposited onto second dielectric layer 14. The second conductive layer 12 preferably comprises a metal that can be used to secure top layer 5 utilizing a laser-bonding process. Layer 12 may, optionally comprise two layers, including a layer of metal oxide over a layer of metal whereby the metal oxide top layer prevents a direct electrical connection between first liquid 15 (FIG. 3) and the metal of layer 12. The layer of second conductive material 12 may form a common connection in liquid lens 1.

At step 50, the second conductor 12 is patterned and etched. At step 52 the etching of second conductor 12 is continued to thereby remove a portion of second dielectric 14. Etching stops on dielectric 13 in the center area to form a circular edge 64 to thereby expose a portion 13B of first dielectric layer 13. The etching also stops on first dielectric layer 13 or on conductive first material 10 in the contact pad areas 62 (FIG. 8).

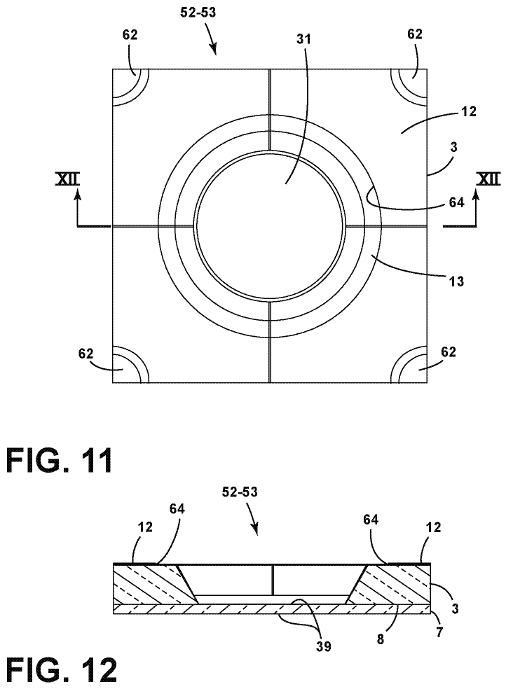

With further reference to FIGS. 11 and 12, at step 52 a laser is used to scribe around the base of the cone opening 31, and the carrier plate 32 is debonded and removed utilizing methods appropriate for the adhesive used to bond the carrier plate 32 (e.g. heat, solvent, laser, etc.). Following removal of the carrier plate 32, a flat plate of glass 7 or other suitable material is bonded to the bottom 8 of intermediate layer 3 utilizing a suitable hermetic method. An optional anti-reflection (AR) coating 39 may be applied to one or both sides of plate 7 either before or after plate 7 is bonded to intermediate layer 3.

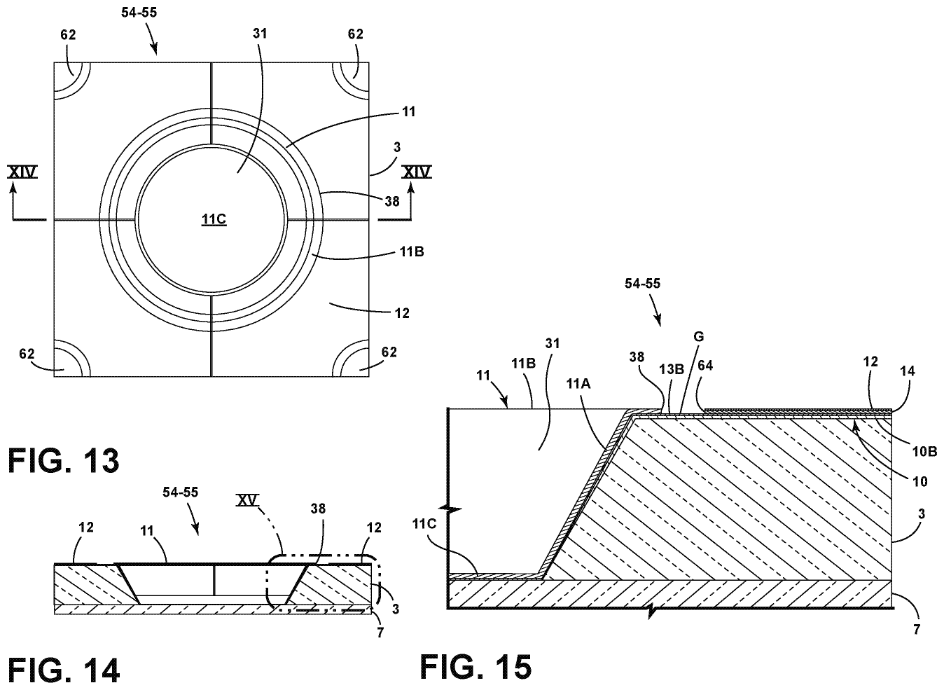

With further reference to FIGS. 13-15, an electrowetting material such as parylene 11 is deposited over first dielectric material 13, and the parylene 11 is then patterned or etched utilizing standard processes to thereby form an outer edge 38. The parylene 11 may include a portion 11A disposed on sidewalls of cone aperture 31, a portion 11B disposed on upper side of intermediate layer 3, and a portion 11C disposed on bottom layer 7. With reference to FIG. 15, the edge 38 of parylene 11 may be spaced apart from edge 64 of second conductor 12 to form a gap “G.” Alternatively, the parylene 11 may be deposited and etched to eliminate the gap G, whereby edges 38 and 64 are directly adjacent one another, or abut (contact) one another. Alternatively, as discussed above in connection with FIG. 3, a portion 11D of parylene 11 may overlap an edge portion 12B of conductive material 12.

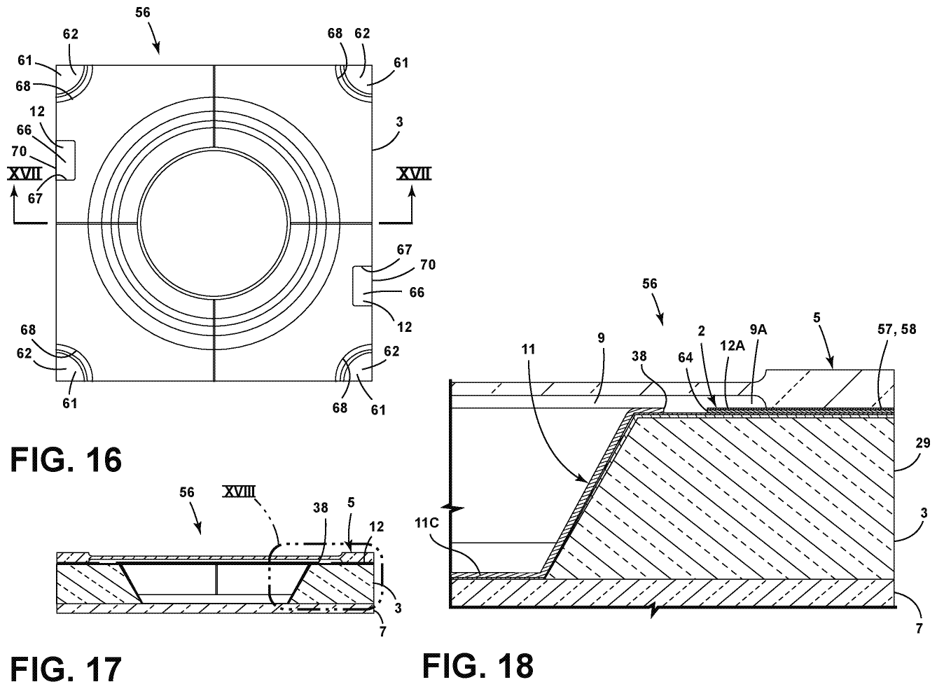

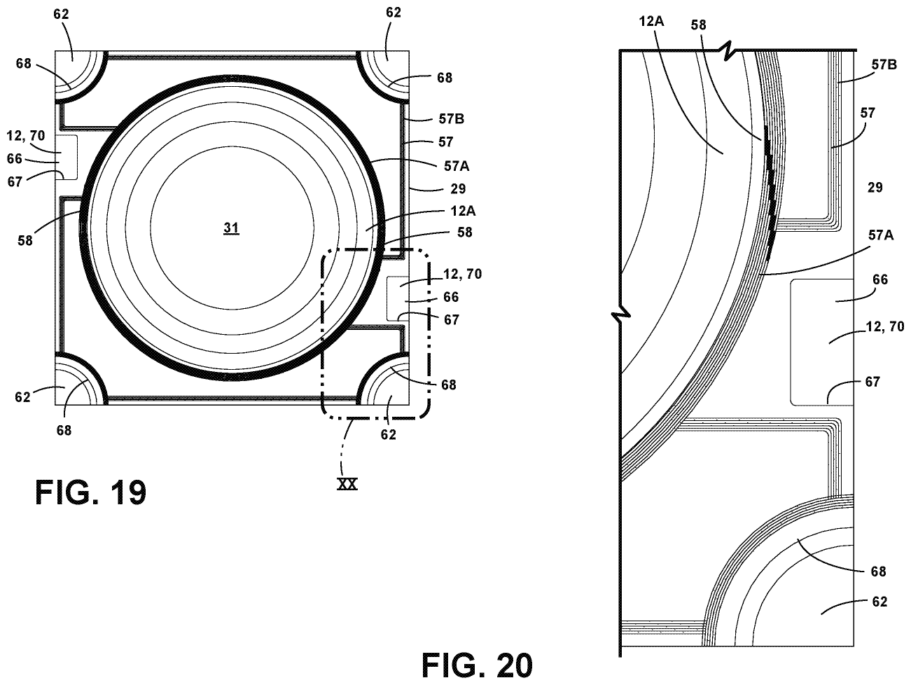

With further reference to FIGS. 16-18, during step 56 (see also FIG. 4C), a top wafer or layer 5 is bonded to second conductor 12 utilizing hard bond 57 and/or soft bond 58 as shown in FIGS. 19 and 20. The top layer 5 comprises a suitable light-transmitting material (e.g. glass). The layer 5 may be pre-cut or etched at corners 61 (FIG. 16) to form edges 68 to thereby expose the Au pads 62. Upper layer 5 may also be etched (removed) to form edges 67 to expose common contact pads 66, which may comprise an exposed surface of second conductor 12.

With reference to FIGS. 19 and 20, hard bonds 57 may be configured to include a central ring 57A that extends around the cone 31, and hard bonds 57 may also include a perimeter portion 57B that extends adjacent perimeter 29. As discussed above, the pads 66 may comprise exposed second conductive material 12. Alternatively, a layer of conductive material 70 may be deposited on the common contact pads 66. The soft bond material 58 may be conductive to electrically interconnect the common contact pads 66 to the ring 12A of second conductive material 12 disposed in edge portion 9A of cavity 9. It will be understood that the configuration of the hard bond 57 and soft bond 58 of FIGS. 19 and 20 is merely an example of one possible configuration, and the top layer 5 may be bonded utilizing virtually any suitable bonding technique. Also, it will be understood that the soft bond 58 is optional, and the common pads 66 may be electrically connected to ring 12A by the conductive layer 12, which may extend to perimeter 29 of liquid lens 1.

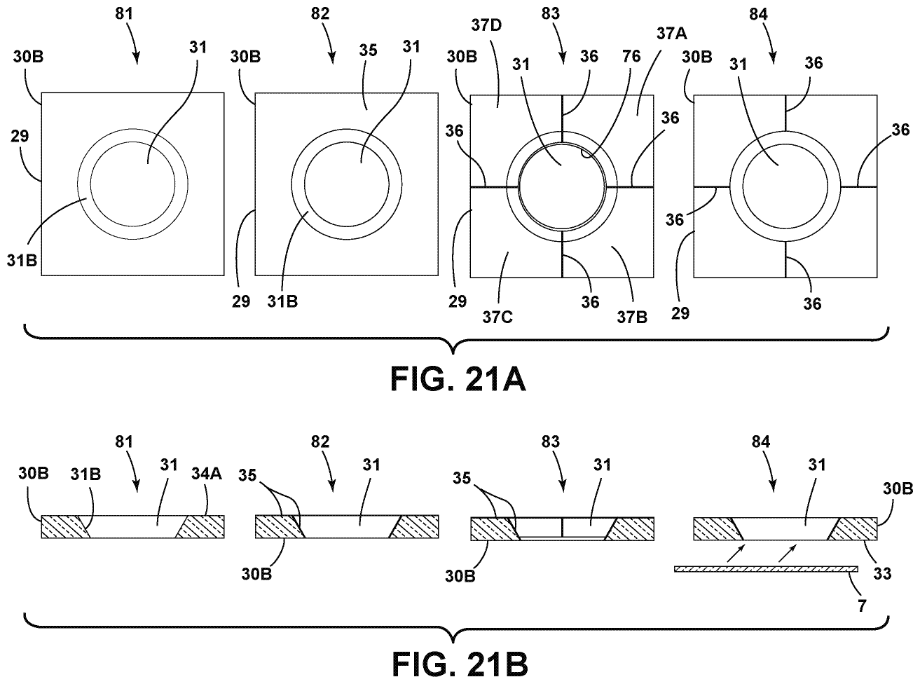

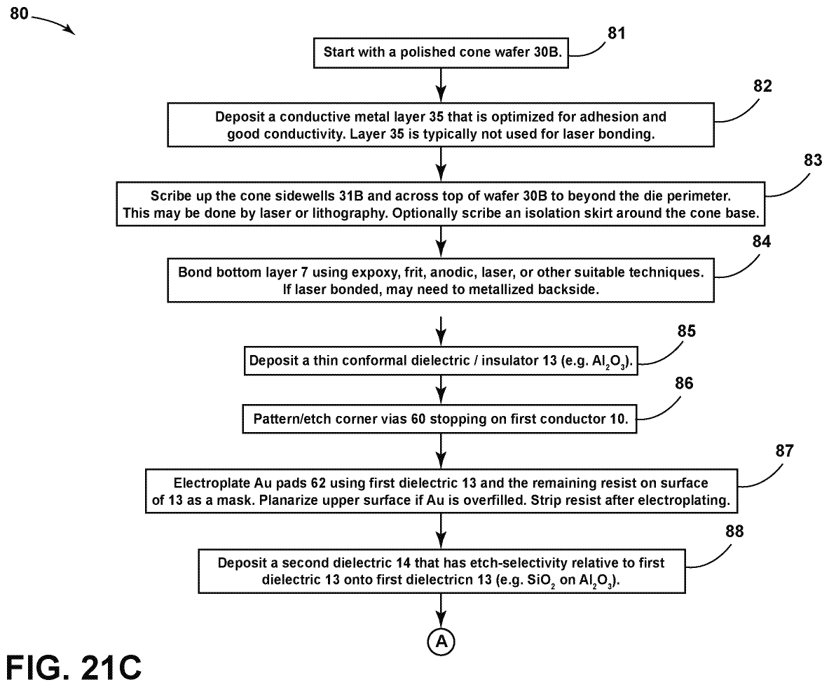

With further reference to FIGS. 21A-21D, in an alternative process 80, a bottom layer 7 is bonded to a cone wafer 30B relatively early in the process (e.g. step 84). Thus, process 80 does not utilize the temporary wafer carrier 32 (of step 42 of process 40 (FIGS. 4B-4D)). In particular, at step 81 (FIGS. 21A-21D), a polished cone wafer 30B is supplied, and a metal layer 35 is deposited onto upper surface 34A and the surface of cone 31B to form first conductor 10 at step 82. At step 83, the metal layer 35 on the cone sidewalls and the top of the wafer 30B are scribed to form gaps 36, which form electrically-isolated regions 37A-37D of conductive layer 35. The scribing may be done by laser, lithography or other suitable process. An optional isolation skirt 76 may be formed by scribing around the base of the cone 31.

At step 84, a bottom layer 7 is bonded to the wafer 30B utilizing epoxy, frit, anodic, laser, or other suitable processes. If laser bonding is utilized, metallization may be performed prior to bonding.

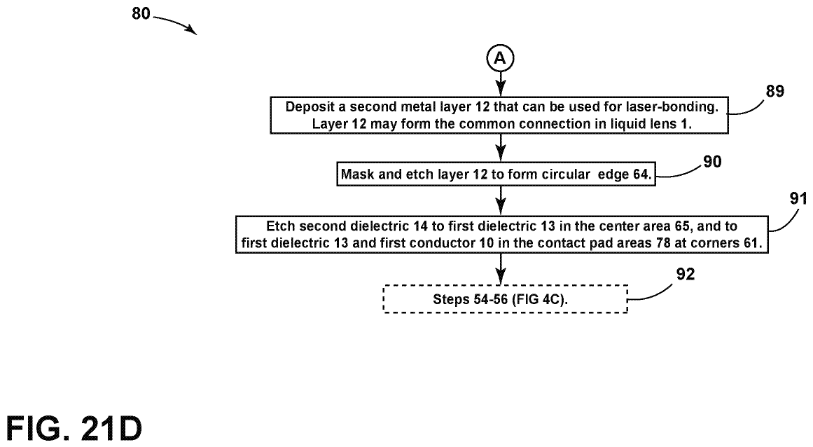

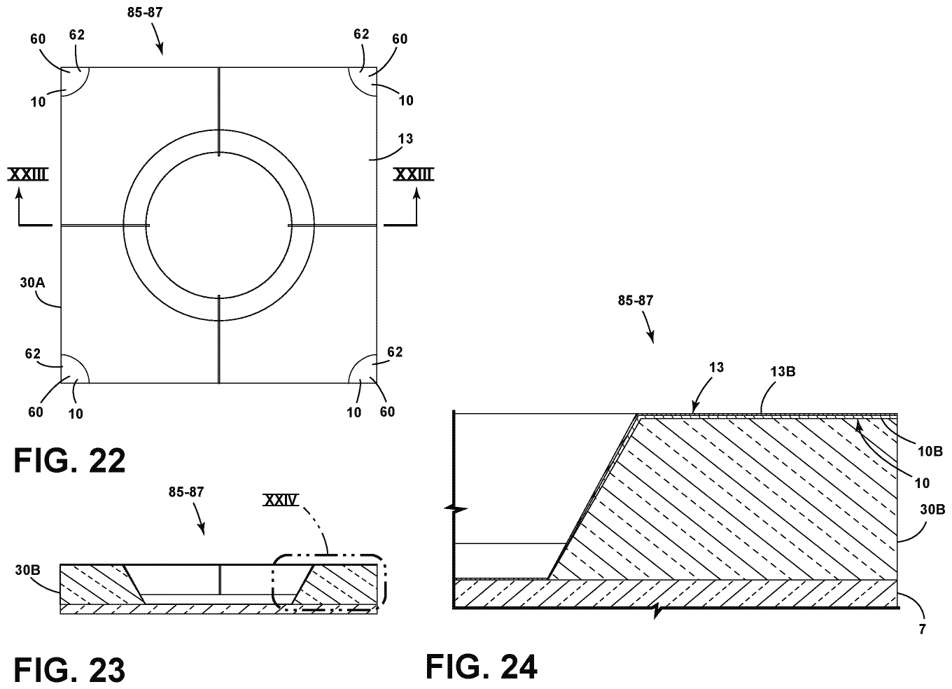

With further reference to FIGS. 22-24 at step 85 a thin conformal dielectric/electrical insulator 13 (e.g. Al₂O₃) is deposited onto wafer 30B. At step 86, corner vias 60 are patterned/etched to remove insulating material 13, stopping on first conductor 10, whereby the conductive material 10 is exposed at corner vias 60. At step 87, the exposed first conductive material 10 is electroplated with a highly conductive material such as Au to form Au pads 62. During electroplating, first dielectric 13 and remaining resist on the surface of dielectric 13 (not shown) may be used as a mask. If the Au pads 62 are overfilled, the upper surface of pads 62 may be planarized utilizing a suitable know process. Any remaining resist may then be stripped after electroplating.

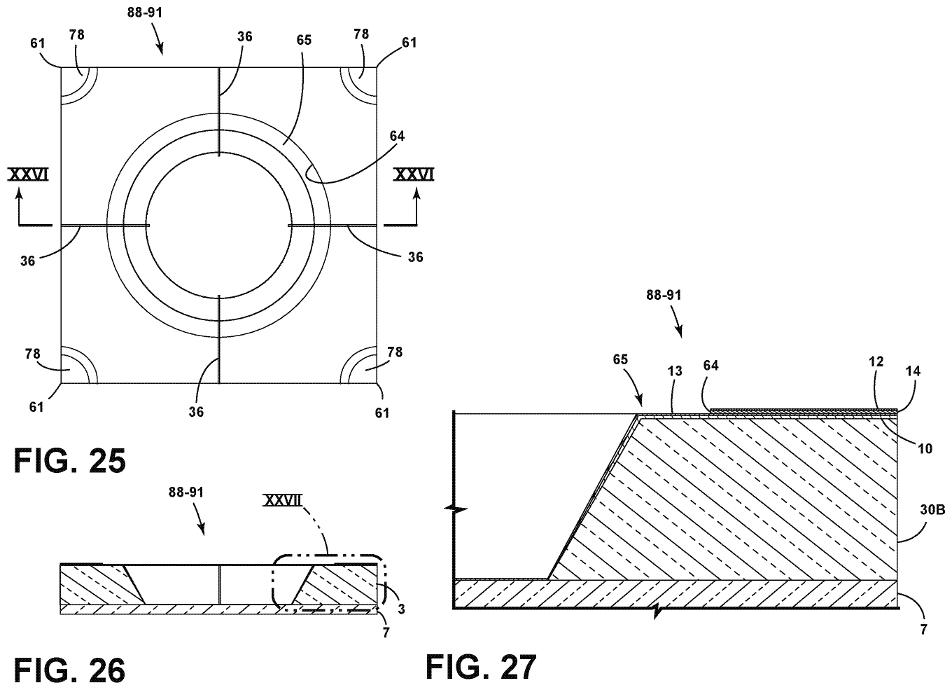

With further reference to FIGS. 25-27, at step 88 a second dielectric 14 is deposited onto first dielectric 13. Second dielectric 14 may comprise SiO₂, and first dielectric 13 may comprise Al₂O₃, whereby second dielectric 14 can be etched (removed) down to the first dielectric 13, without removing the first dielectric 13. In this manner, first dielectric 13 can act as an etch stop to enable etching second dielectric 14, leaving first dielectric 13 in place.

At step 89, a second metal layer 12 is deposited onto second dielectric 14. The material of second metal layer 12 is preferably selected to be suitable for laser-bonding. As discussed in more detail below, the second conductive layer 12 may form the common electrical connection in the finished liquid lens 1.

At step 90, the second metal layer 12 is masked and etched to form an edge 64. As show in FIG. 25, edge 64 may be circular and extend around center area 65 of the lens subassembly. At step 91, second dielectric 14 is etched to first dielectric 13 in the center area 65, and to first conductor 10 in the corner contact pad areas 78. Step 91 may include a second etching step to remove first dielectric 13 in corner contact pad areas 78 to thereby expose first conductor 10 in areas 78.

After completion of step 91, the lens can be finished utilizing process steps 54-56 as described in more detail above in connection with FIGS. 13-20. Thus, step 92 of FIG. 21D generally corresponds to steps 54-56 of FIG. 4D.

With reference to FIG. 28, a process 101 according to another aspect of the present disclosure includes steps 102-107. Steps 102-106 generally correspond to FIGS. 29A-29E, respectively. At step 102, a transparent material such as glass layer 97 is bonded (e.g. anodically) to a piece of material such as silicon wafer 93 to form a subassembly or blank 100. In other embodiments, transparent material 97 may be bonded to material 90 prior to the liquid lens fabrication process. For example, a silicon-on-glass wafer may be used as a starting material for the remaining steps. At step 103 photoresist 110 is applied to an upper surface 112 of silicon wafer 93 and the photoresist 110 is patterned to expose upper surface 112 in a center area 114. At step 104, the silicon material 93 is dry etched to form a conical (cone) opening 116 having conical sidewalls 118, and photoresist 110 is then stripped at step 105. At step 106, an optional antireflective coating 120 is deposited on a lower side 98 of glass 97 at bottom window 122.

At step 107 (FIG. 28), the fabrication process of a liquid lens then proceeds substantially as described above in connection with FIGS. 21A-24. More specifically, the conductive layer 35 is deposited and scribed as described at steps 82 and 83 to form first conductor 10, and the process then continues as described in more detail above in connection with FIGS. 22-24, including steps 54-56.

The process of FIG. 28 and FIGS. 29A-29E may utilize commercially available glass on silicon wafers (GOS) and deep dry etching processes to form the cone 116 in the silicon wafer 93. The glass 97 acts as an etch stop and forms an integrated bottom window 122. The process also eliminates the need to fabricate a cone wafer and a bottom wafer separately, and it may also eliminate a separate step associated with the bottom wafer-to-cone bond. The process of FIGS. 28 and 29A-29E may also eliminate the need for subsequent grinding and polishing steps. Still further, the silicon wafer 93 does not leech unwanted ions into polar fluid 15 (e.g. water), thereby providing increased reliability and eliminating any potential need for a separate barrier layer. Still further, if necessary, the geometry of the surface 118 of cone 116 can be modified by adjusting the photolithography patterning process.

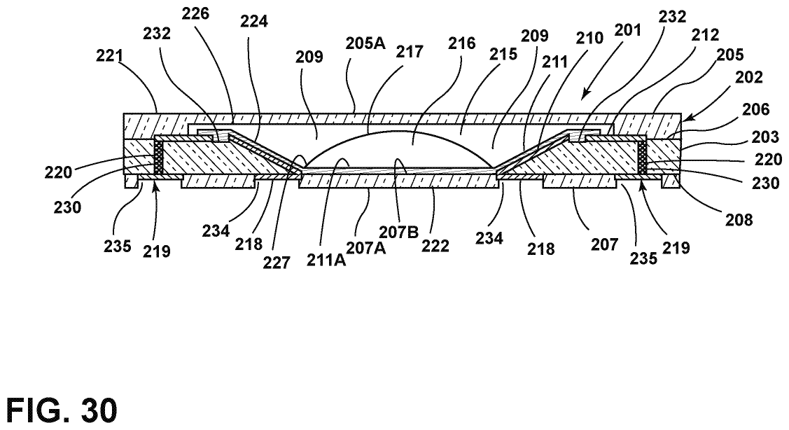

With reference to FIG. 30, a liquid lens 201 according to another aspect of the present disclosure includes a body 202. The body 202 may include an intermediate layer 203 having a bore 204 extending through the intermediate layer 203. The body 202 may further include a first (top) layer 205 disposed on a first (top) side 206 of the intermediate layer 203, and a second (bottom) layer 207 disposed on a second (bottom) side 208 of the intermediate layer 203 that is opposite the first side 206 of the intermediate layer 203. The body 202 includes a cavity 209 that is defined, at least in part, by the bore 204 through the intermediate layer 203.

The liquid lens 201 may include a conductive first liquid 215 disposed in the cavity 209, and a non-conductive second liquid 216 that is also disposed in the cavity 209. An interface 217 is disposed between the first and second liquids 215, 216, respectively. First conductive material 210 is disposed on at least a portion of the bore 204, and a dielectric material 211 covers at least a portion of the first conductive material 210, whereby the first and second liquids 215, 216, respectively, do not directly contact the first conductive material 210 due to the dielectric material 211. The liquid lens 201 further includes second conductive material 212 disposed on at least a portion of the first side 206 of the intermediate layer 203 in electrical communication with the first liquid 215 in the cavity 209. The first conductive material 210 is electrically connected to one or more anodes or first contacts 218 disposed on the second side 208 of the intermediate layer 203. The second conductive material 212 is electrically connected to one or more cathodes or second contacts 219 disposed on the second side 208 of the intermediate layer 203 by one or more conductive vias 220 extending through the intermediate layer 203. The interface 217 has a shape that is influenced by a voltage differential between the one or more first contacts 218 and the one or more second contacts 219.

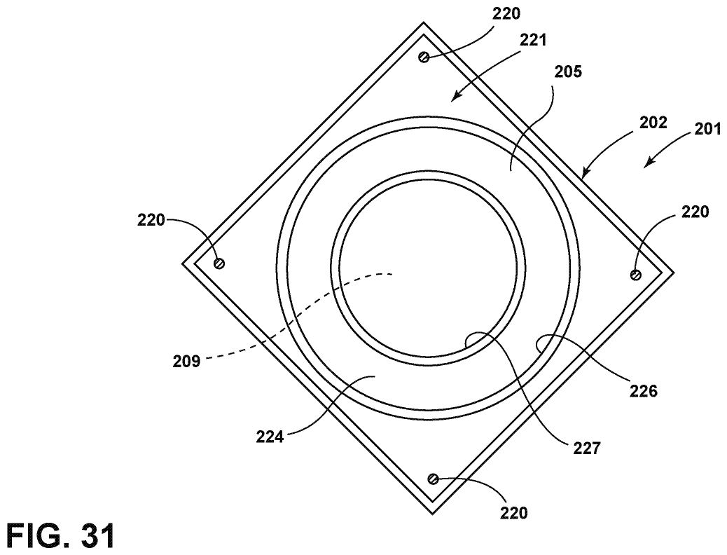

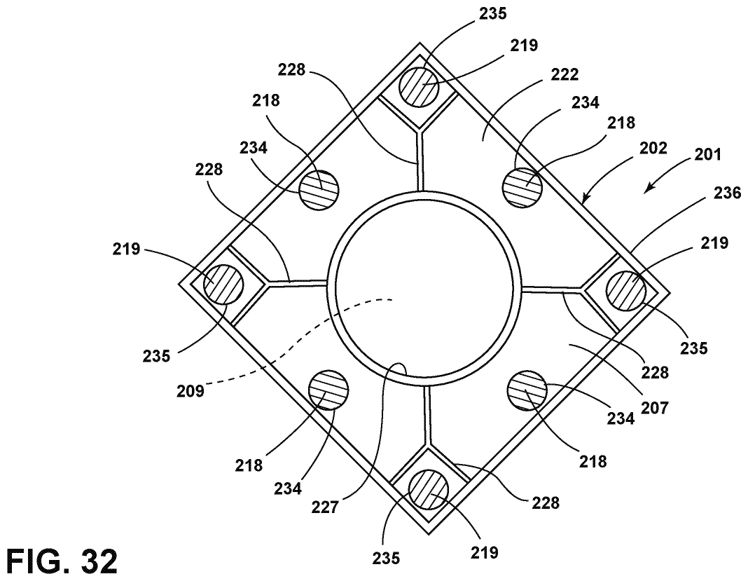

With reference to FIGS. 30-32, the vias 220 permit the first contacts 218 and second contacts 219 to be positioned on a second (bottom) side 222 of liquid lens 201 that is opposite a first (top) side 221 of liquid lens 201. The bore 204 may be frusto-conical, with a conical side surface 224. Intermediate layer 203 may be formed from a non-conductive material (e.g., glass), and the bore 204 may be formed in the intermediate layer 203 by pressing or other suitable processes that are generally known in the art. In use, light passes through a central portion 205A of first layer 205, through first and second liquids 215, 216, through a central portion 211A of dielectric material 211 and through a central portion 207A of second layer 207. In contrast to known liquid lenses which may have one or more first contacts 218 and/or second contacts 219 disposed on the first side 221 of liquid lens 201, the liquid lens 201 positions the first contacts 218 and second contacts 219 on second side 222 of liquid lens 201. In general, the conical side surface 224 includes a first circular edge 226 and a second circular edge 227 where the conical side surface 224 ends at the first side 206 of intermediate layer 203 and second side 208 of intermediate layer 203, respectively. Due to the conical shape of bore 204, the second side 222 of liquid lens 201 has significantly greater area to accommodate the first contacts 218 and second contacts 219 (FIG. 32) compared to the first side 221 (FIG. 31) of liquid lens 201.

During fabrication, a non-conductive wafer is utilized to form intermediate layer 203. For example, the intermediate layer 203 may be formed from a glass wafer, and the bore 204 may be formed by pressing utilizing known techniques and processes. One or more openings 230 extending through intermediate layer 203 may be formed by a suitable process such as laser drilling, wet etching, or dry etching. The openings 230 for vias 220 may be formed either before or after formation of bore 204.

After the openings 230 are formed in intermediate layer 203, the openings 230 are at least partially filled with conductive via material. The openings 230 may be filled with the conductive material of vias 220 utilizing an electrode-plating process or other suitable process. The conductive material of vias 220 is preferably a metal (e.g., nickel, copper, aluminum, or other suitable material).

During fabrication, the via openings 230 may be created and filled with conductive via material 220 after the bore 204 is initially pressed, but prior to final grinding/polishing of first and second sides 206 and/or 208 of intermediate layer 203. Conducting final grinding and polishing on opposite sides 206 and 208 after joining openings 230 with conductive via material 220 may help planarize the material of the conductive vias 220 and/or the material of intermediate layer 203.

With reference to FIGS. 30 and 32, the first contacts 218 and second contacts 219 may be formed by conductive material 210 that is disposed on second side 208 of intermediate layer 203, and on conical side surface 224 of intermediate layer 203. Isolation channels 228 (FIG. 32) may be cut in the conductive material 210 and filled with dielectric material 211 to thereby isolate the first contacts 218 and second contacts 219. It will be understood that the arrangement of isolation channels 228 shown in FIG. 32 is merely one example of a possible configuration. As shown in FIGS. 30 and 32, openings or cutouts 234, 235 may be formed through second layer 207 to provide access to first contacts 218 and second contacts 219, respectively. In general, the cutouts 234 and/or 235 may be formed in second layer 207 before second layer 207 is bonded to the intermediate layer 203. Alternatively, the cutouts 234 and/or 235 may be formed in second layer 207 after second layer 207 is bonded to second side 208 of the intermediate layer 203.

Referring again to FIG. 30, the first and second conductive materials 210, 212 may initially comprise a single layer of conductive material that is deposited on conical side surface 224 of intermediate layer 203 and on first side 206 of intermediate layer 203. Isolation channels 232 may then be cut to separate first conductive material 210 from second conductive material 212, and dielectric material 211 may then be deposited over conductive material 210 disposed on conical side surface 224, and in isolation channels 232. However, a portion of the conductive material 212 is not covered by the dielectric material 211 such that the first liquid 215 is in electrical communication with conductive material 212 and second contacts 219 (due to conductive vias 220). A portion 211A of the dielectric material 211 may also be deposited over a central inner side surface 207B of second layer 207. The dielectric portion 211A is preferably light transmitting to thereby permit light to pass through liquid lens 201 in use.

In general, the conductive vias 220 may be located so as to minimize capacitance between first contacts 218 and second contacts 219. In the illustrated example of FIGS. 30-32, the first contacts 218 and second contacts 219 are positioned directly adjacent to perimeter 236 (FIG. 32) of liquid lens 201 to thereby maximize spacing between first contacts 218 and second contacts 219. However, it will be understood that the first contacts 218 and second contacts 219 may be positioned in virtually any location as required for a particular application. Also, each second contact 219 may be electrically connected to the second conductive material 212 by a plurality of conductive vias 220 to thereby ensure electrical contact. However, because the liquid lens 201 operates without current, the diameter of the conductive vias 220 may be minimized. For example, the conductive vias 220 may have a diameter of 20 mm, 10 mm, 5 mm, or less.

A liquid lens 201 according to the present disclosure may permit an improved lens design and resolve at least some technical issues associated with existing liquid lens designs. For example, the ability to position one or more second contacts 219 on the second (bottom) side 222 provides more design freedom by providing additional area for the electrical contacts. In the illustrated example, the liquid lens 201 includes four first contacts 218 and four second contacts 219. However, it will be understood that a liquid lens 201 according to the present disclosure may include fewer first contacts 218 or second contacts 219, or it may include a greater number of first contacts 218 or second contacts 219. In general, the bottom side 222 of liquid lens 201 includes a larger area for first contacts and second contacts 218, 219, respectively, thereby permitting a larger number of first contacts and second contacts 218, 219 as may be required for a particular application.

Furthermore, a liquid lens 201 according to the present disclosure permits transparent dicing lanes for laser singulation, and also permits space on the first side 221 of liquid lens 201 to provide unique identifier marks (e.g., product serial number or the like to permit product traceability). Furthermore, a liquid lens 201 according to the present disclosure provides additional space for lens encapsulation, and also allows for single side probing for electro-optical testing, thereby reducing testing complexity.

It will be understood that any features shown in any of the drawings may be combined with any of the other features of any of the drawings. For example, one or more of the vias described in connection with FIGS. 30-32 may be utilized in a liquid lens or components described in connection with FIGS. 1-29E. Thus, a liquid lens according to the present disclosure may utilize one or more vias as described in connection with FIG. 30-32 in combination with one or more of the electrical connections on a top side of a liquid lens (FIG. 1-29E). Similarly, the vias of FIGS. 30-32 may be utilized in connection with a silicon wafer (FIG. 28-29E).

In some embodiments, a method of making a liquid lens comprises etching a recess in a layer of silicon, wherein the recess includes a conical side surface formed in the layer of silicon and a base surface formed by a surface of a first layer of glass bonded to the layer of silicon, wherein the conical side surface defines first and second circular edges at first and second sides, respectively, of the layer of silicon, wherein the first layer of glass is bonded to the second side of the layer of silicon. A first conductive material can be deposited onto at least a portion of the conical side surface and on at least a portion of the first side of the layer of silicon. A first dielectric material can be deposited onto at least a portion of the first conductive material. At least a portion of the first dielectric material on the conical side surface can be covered with an electrically insulating material that is configured to provide an electrowetting interface with a conductive liquid. A first electrode can be electrically connected to the first conductive material. A second dielectric material can be deposited onto at least a portion of the first dielectric material on the first side of the layer of silicon. A second conductive material can be deposited onto at least a portion of the second dielectric material. A second electrode can be electrically connected to the second conductive material. Conductive and non-conductive liquids can be deposited in the recess, an interface defined between the conductive and non-conductive liquids. A second layer of glass can be bonded to the first side of the layer of silicon to close off the recess and form a cavity. The second conductive material can be electrically connected to the conductive liquid in the cavity. The first and second electrodes can be positioned on the first side of the layer of silicon.

The second layer of glass can be bonded to the first side of the layer of silicon utilizing a laser bonding process.

The first conductive material on the conical side surface and on the first side of the layer of silicon can be scribed to form elongated gaps between at least two portions of the first conductive material.

The first dielectric material can be deposited onto the first conductive material after scribing the first conductive material. A portion of the first dielectric material on each of the at least two portions of the first conductive material can be removed to form vias. The vias can be electroplated with a layer of conductive pad material.

The second dieletric material can have an etch selectivity relative to the first dielectric material whereby the second dielectric material can be removed by etching without substantially removing the first dielectric material. A portion of the second conductive material on the first side of the layer of silicon can be masked, leaving a portion of the second conductive material unmasked. The unmasked second conductive material and the second dielectric material below the unmasked second conductive material can be removed, whereby the second conductive material and the second dielectric material form an edge that is spaced-apart from the circular edge of the conical side surface, and a portion of the first dielectric material on the first side of the layer of silicon is exposed.

At least a portion of the electrowetting material can be deposited onto the second dielectric material around the conical side surface on the first side of the layer of silicon. The second layer of glass can include a raised portion and a peripheral portion extending around the raised portion, wherein the peripheral portion is sealingly bonded to a peripheral portion of the second conductive material, and wherein the raised portion is spaced-apart from an exposed inner portion of the second conductive material to form a gap portion of the cavity, whereby conductive liquid disposed in the gap portion of the cavity is in electrical contact with the exposed inner portion of the first conductive material.

The layer of silicon can have a quadrilateral perimeter with four corners. The first conductive material can be scribed to divide the first conductive material into four electrodes. A portion of the first dielectric material at each corner can be removed to form a via at each corner. Each via can be electroplated with a layer of contact pad material comprising gold.

The first and second conductive materials can have substantially identical material compositions.

The cavity can be etched into the layer of silicon utilizing a dry etching process.

In some embodiments, a method of making a liquid lens comprises bonding a bottom layer of glass to a bottom side of a layer of material. A recess can be formed in the layer of material, wherein the recess includes a conical side surface formed in the layer of material and a base surface formed by a surface of the bottom layer of glass. A first conductive material can be deposited onto at least a portion of the conical side surface of the layer of material. An electrically insulating electrowetting material can be deposited over at least a portion of the first conductive material. A first electrode can be electrically connected to the first conductive material. Conductive and non-conductive liquids can be deposited in the recess, an interface defined between the conductive and non-conductive liquids. A top layer of glass can be bonded to a top side of the layer of material opposite the bottom side to close off the recess and form a cavity. A second conductive material can be electrically connected to a second electrode and to the conductive liquid in the cavity, whereby a voltage can be applied to the first and second electrodes to influence a shape of the interface.

The layer of material can comprise a layer of silicon. The first conductive material can be deposited onto at least a portion of the top side of the layer of silicon. A first dielectric material can be deposited over at least a portion of the first conductive material. A second dielectric material can be deposited over at least a portion of the first dielectric material on the top side of the layer of silicon. The first and second electrodes can be positioned on the top side of the layer of silicon.

An electrically conductive via can be formed extending through the layer of material. The second electrode can be disposed on the bottom side of the layer of material.

The first electrode can be disposed on the bottom side of the layer of material.

In some embodiments, a method of making a liquid lens having top-only electrical connections comprises depositing a first conductive material onto a layer of material having a top side and a bottom side that is opposite the top side, and a recess, wherein the recess includes a conical side surface, wherein the conical side surface defines first and second circular edges forming top and bottom openings at the top and bottom sides, respectively, of the layer of material, whereby the first conductive material is deposited onto at least a portion of the conical side surface and at least a portion of the top side of the layer of material. A first dielectric material can be deposited onto at least a portion of the first conductive material. At least a portion of the first dielectric material on the conical side surface can be covered with an electrowetting material that is configured to provide an electrowetting interface with a conductive liquid. A first electrode can be electrically connected to the first conductive material. A second dielectric material can be deposited onto at least a portion of the first dielectric material on the top side of the layer of material. A second conductive material can be deposited onto at least a portion of the second dielectric material. A second electrode can be electrically connected to the second conductive material. A bottom layer of glass can be bonded to the bottom side of the layer of material to close off the bottom opening of the recess. Conductive and non-conductive liquids can be deposited in the recess, an interface defined between the conducive and non-conductive liquids. A top layer of glass can be bonded to the top side of the layer of material to close off the top opening of the recess to form a cavity, wherein at least a portion of the second conductive material is electrically connected to the cavity. The second conductive material can be electrically connected to the conductive liquid in the cavity. The first and second electrodes can be positioned on the top side of the layer of material, whereby a voltage can be applied to the first and second electrodes to influence a shape of the interface.

A temporary bottom layer can be bonded onto the bottom side of the layer of material to close off the bottom opening, followed by depositing the first conductive material onto a portion of the temporary bottom layer extending across the bottom opening. The temporary bottom layer can be removed prior to bonding the bottom layer of glass to the bottom side of the layer of material. The first conductive material on the conical side surface can be cut around the bottom opening in the layer of material prior to removing the temporary bottom layer. The first conductive material deposited on the portion of the temporary bottom layer extending across the bottom opening can be electrically connected to the first conductive material on the conical side surface. A portion of the first dielectric material on the top side of the layer of material can be removed to form exposed portions of the first conductive material. A conductive material can be electroplated onto the exposed portions of the first conductive material utilizing an electrical connection to the first conductive material on the portion of the temporary bottom layer extending across the bottom opening.

The second dielectric material can be etch-selective, whereby the second dielectric material can be selectively removed by etching without removing the first dielectric material. A portion of the second conductive material and the second dielectric material on the top side of the layer of material can be removed around the top opening utilizing an etching process.

The electrowetting material can be deposited onto the first dielectric material after the bottom layer of glass is bonded to the bottom side of the layer of material. The electrowetting material can be deposited onto the bottom layer of glass, the conical side surface of the layer of material extending around the top opening.

The bottom layer of glass can be bonded to the bottom side of the layer of material before the first dielectric material is deposited onto the first conductive material.

In some embodiments, a liquid lens comprises an intermediate layer comprising a tapered cavity having a wide end and a narrow end. A first outer layer can be bonded to a top side of the intermediate layer at the wide end of the tapered cavity. A second outer layer can be bonded to a bottom side of the intermediate layer at the narrow end of the tapered cavity. A chamber can be formed, at least in part, by the tapered cavity, the first outer layer, and the second outer layer. A first fluid can be contained in the chamber. A second fluid can be contained in the chamber. A fluid interface can be between the first fluid and the second fluid. One or more first electrodes can be insulated from the first and second fluids, wherein the one or more first electrodes comprise a first layer of conductive material disposed on at least a portion of the tapered cavity and on at least a portion of the top side of the intermediate layer. Each of the one or more first electrodes can include a conductive pad on the top side of the intermediate layer for connection to a voltage source. A second electrode can be in electrical communication with the first fluid, wherein the second electrode comprises a second layer of conductive material disposed on the top side of the intermediate layer. The second electrode can include a conductive pad on the top side of the intermediate layer for connection to a voltage source. A position of the fluid interface can be based at least in part on voltage applied between the first and second electrodes.

The intermediate layer can comprise silicon. The first outer layer can comprise glass. The second outer layer can comprise glass.

The intermediate layer can comprise glass.

A layering of insulating material can be disposed between the first layer of conductive material and the second layer of conductive material on the top side of the intermediate layer. The layer of insulating material can comprise a first layer of insulating material disposed on the first layer of conductive material in the cavity and on the first layer of conductive material on the top side of the intermediate layer and a second layer of insulating material disposed between the first layer of insulating material and the first layer of conductive material. A layer of electrowetting insulating material can be disposed on the first layer of insulating material in the cavity.

The first layer of conductive material can include a plurality of regions in the cavity that are electrically isolated from each other to form a plurality of first electrodes. The plurality of first electrodes can comprise at least four first electrodes. The first layer of conductive material of each first electrode can include a region in the cavity that is electrically connected to a region of the first layer of conductive material on the top side of the intermediate layer.

The tapered cavity can be formed by a conical surface of the intermediate layer. The first outer layer can be bonded to the second layer of conductive material. A portion of the first outer layer can be spaced apart from an interior portion of the second layer of conductive material in the chamber such that the interior portion of the second layer of conductive material is electrically connected to one of the first and second fluids.

In some embodiments, a liquid lens comprises a body including an intermediate layer having a bore therethrough. The body can include a first layer disposed on a first side of the intermediate layer and a second layer disposed on a second side of the intermediate layer that is opposite the first side of the intermediate layer. The body can have a cavity defined, at least in part, by the bore through the intermediate layer. A conductive first liquid can be disposed in the cavity. A non-conductive second liquid can be disposed in the cavity. An interface can be formed between the first and second liquids. A first conductive material can be disposed on at least a portion of the bore. A dielectric material can cover at least a portion of the first conductive material, whereby the first and second liquids do not directly contact the first conductive material due to the dielectric material. A second conductive material can be disposed on at least a portion of the first side of the intermediate layer in electrical communication with the first liquid in the cavity. The first conductive material can be electrically connected to an anode disposed on the second side of the intermediate layer. The second conductive material can be electrically connected to a cathode disposed on the second side of the intermediate layer by a conductive via extending through the intermediate layer. The interface can have a shape that is influenced by a voltage differential between the anode and the cathode.

At least a portion of the first layer can comprise a light-transmitting material, and at least a portion of the second layer comprises a light-transmitting material, whereby light passes through the first and second layers and through the first and second liquids in the cavity.

The second layer can have an inner side facing the cavity. Light-transmitting dielectric material can be disposed on the inner side of the second layer, whereby the second liquid does not contact the inner side of the second layer.

The light-transmitting dielectric material can be disposed on the inner side of the second layer and the dielectric material can cover at least a portion of the first conductive material to comprise a substantially continuous layer of dielectric material.

The bore can have a frusto-conical shape forming first and second circular openings on the first and second sides, respectively, of the intermediate layer. The first circular opening can be larger than the second circular opening. The anode can be electrically connected to the first conductive material by conductive material that extends from the anode through the second circular opening to the first conductive material.

The second layer can include apertures at the anode and cathode to provide access to the anode and the cathode through the second layer.

The anode and the cathode can comprise a layer of conductive material disposed on the second side of the intermediate layer, wherein the layer of conductive material has been cut to form gaps that electrically isolate the anode and cathode from each other.

The intermediate layer can comprise an electrically non-conductive material. The first layer can comprise an electrically non-conductive material. The second layer can comprise an electrically non-conductive material. The intermediate layer can comprise glass. The conductive via can comprise metal. The second conductive material can be electrically connected to the cathode by a plurality of conductive vias extending through the intermediate laver.

In some embodiments, a liquid lens comprises a body including an intermediate layer having a bore therethrough. The body can include a first layer disposed on a first side of the intermediate layer and a second layer disposed on a second side of the intermediate layer that is opposite the first side of the intermediate layer. The body can have a cavity defined, at least in part, by the bore through the intermediate layer. A conductive first liquid can be disposed in the cavity. A non-conductive second liquid can be disposed in the cavity. An interface can be disposed between the first and second liquids. A first conductive material can form a first electrical contact on a second side of the body. A second conductive material can be disposed on at least a portion of the first side of the intermediate layer in electrical communication with the first liquid in the cavity. The second conductive material can be electrically connected to a second electrical contact on the second side of the body by a conductive via extending at least partially through the intermediate layer. The interface can have a shape that is influenced by a voltage differential between the first electrical contact and the second electrical contact.

The first conductive material can be disposed on at least a portion of the bore. A dielectric material can cover at least a portion of the first conductive material, whereby the first and second liquids do not directly contact the first conductive material due to the dielectric material.

The first and second layers can comprise light-transmitting material that is bonded to the intermediate layer. The second layer can have an inner side facing the cavity and
light-transmitting dielectric material disposed on the inner side of the second layer, whereby the second liquid does not contact the inner side of the second layer. The light-transmitting dielectric material can be disposed on the inner side of the second layer, and the dielectric material can cover at least a portion of the first conductive material to comprise a substantially continuous layer of dielectric material.

The bore can have a frusto-conical shape forming first and second circular openings on the first and second sides, respectively, of the intermediate layer. The first circular opening can be larger than the second circular opening. The anode can be electrically connected to the first conductive material by conductive material that extends from the anode through the second circular opening to the first conductive material.

The intermediate layer can comprise an electrically non-conductive material. The first layer can comprise an electrically non-conductive material. The second layer can comprise an electrically non-conductive material.

In some embodiments, a method of making a liquid lens comprises forming a bore through a wafer having first and second opposite sides. At least one hole can be formed through the wafer. The at least one hole can be at least partially filled with a conductive via material. A first conductive material can be deposited on at least a portion of the bore. A dielectric material can be deposited on at least a portion of the first conductive material. A second conductive material can be deposited on at least a portion of the first side of the wafer. The second conductive material can be electrically connected to the conductive via material. A first layer of material can be bonded to the first side of the wafer. A second layer of material can be bonded to the second side of the wafer, conductive first liquid can be disposed in a cavity formed, at least in part, by the bore through the wafer, the first layer, and the second layer. A non-conductive second liquid can be disposed in the cavity, whereby an interface is formed between the first and second liquids. A first electrical contact can be formed that is electrically connected to the first conductive material deposited on the bore. A second electrical contact can be formed that is electrically connected to the conductive via material. The first and second electrical contacts can be disposed on a second side of the liquid lens adjacent to the second side of the wafer.

The first electrical contact can be formed by depositing conductive material on the second side of the wafer. The second electrical contact can be formed by depositing conductive material on the second side of the wafer.

The wafer can comprise glass. The at least one hole through the wafer can be formed by a process selected from the group consisting of laser drilling, wet etching, and dry etching. The wafer can comprise a non-conductive material. The wafer can comprise silicon. The at least one hole through the wafer can be formed utilizing an etching process.

It will be apparent to those skilled in the art that various modifications and variations can be made without departing from the spirit or scope of the claims.

What is claimed is:

1. A method of making a liquid lens, the method comprising:
etching a recess in a layer of silicon, wherein the recess includes a conical side surface formed in the layer of silicon and a base surface formed by a surface of a first layer of glass bonded to the layer of silicon, wherein the conical side surface defines first and second circular edges at first and second sides, respectively, of the layer of silicon, wherein the first layer of glass is bonded to the second side of the layer of silicon;
depositing a first conductive material onto at least a portion of the conical side surface and on at least a portion of the first side of the layer of silicon;
depositing a first dielectric material onto at least a portion of the first conductive material;
covering at least a portion of the first dielectric material on the conical side surface with an electrically insulating material that is configured to provide an electrowetting interface with a conductive liquid;
electrically connecting a first electrode to the first conductive material;
depositing a second dielectric material onto at least a portion of the first dielectric material on the first side of the layer of silicon;
depositing a second conductive material onto at least a portion of the second dielectric material;
electrically connecting a second electrode to the second conductive material;
depositing conductive and non-conductive liquids in the recess, an interface defined between the conductive and non-conductive liquids;
bonding a second layer of glass to the first side of the layer of silicon to close off the recess and form a cavity;
causing the second conductive material to be electrically connected to the conductive liquid in the cavity;
wherein the first and second electrodes are positioned on the first side of the layer of silicon.

2. The method of claim 1, wherein:
the second layer of glass is bonded to the first side of the layer of silicon utilizing a laser bonding process.

3. The method of claim 1, including:
scribing the first conductive material on the conical side surface and on the first side of the layer of silicon to form elongated gaps between at least two portions of the first conductive material.

4. The method of claim 3, wherein:
the first dielectric material is deposited onto the first conductive material after scribing the first conductive material; and including;
removing a portion of the first dielectric material on each of the at least two portions of the first conductive material to form vias; and:
electroplating the vias with a layer of conductive pad material.

5. The method of claim 4, wherein:
the second dieletric material has etch selectivity relative to the first dielectric material whereby the second dielectric material can be removed by etching without substantially removing the first dielectric material; and including:
masking a portion of the second conductive material on the first side of the layer of silicon, leaving a portion of the second conductive material unmasked;
removing the unmasked second conductive material and the second dielectric material below the unmasked second conductive material whereby: 1) the second conductive material and the second dielectric material form an edge that is spaced-apart from the circular edge of the conical side surface, and: 2) a portion of the first dielectric material on the first side of the layer of silicon is exposed.

6. The method of claim 5, wherein:
at least a portion of the electrowetting material is deposited onto the second dielectric material around the conical side surface on the first side of the layer of silicon;
the second layer of glass includes a raised portion and a peripheral portion extending around the raised portion, wherein the peripheral portion is sealingly bonded to a peripheral portion of the second conductive material, and wherein the raised portion is spaced-apart from an exposed inner portion of the second conductive material to form a gap portion of the cavity whereby conductive liquid disposed in the gap portion of the cavity is in electrical contact with the exposed inner portion of the first conductive material.

7. The method of claim 6, wherein:
the layer of silicon has a quadrilateral perimeter with four corners;
the first conductive material is scribed to divide the first conductive material into four electrodes;
a portion of the first dielectric material at each corner is removed to form a via at each corner;
each via is electroplated with a layer of contact pad material comprising gold.

8. The method of claim 1, wherein:
the first and second conductive materials have substantially identical material compositions.

9. The method of claim 1, wherein:
the cavity is etched into the layer of silicon utilizing a dry etching process.

10. A method of making a liquid lens, the method comprising:
bonding a bottom layer of glass to a bottom side of a layer of material;
forming a recess in the layer of material, wherein the recess includes a conical side surface formed in the layer of material and a base surface formed by a surface of the bottom layer of glass;
depositing a first conductive material onto at least a portion of the conical side surface of the layer of material;
depositing an electrically insulating electrowetting material over at least a portion of the first conductive material;
electrically connecting a first electrode to the first conductive material;
depositing conductive and non-conductive liquids in the recess, an interface defined between the conductive and non-conductive liquids;
bonding a top layer of glass to a top side of the layer of material opposite the bottom side to close off the recess and form a cavity;
causing a second conductive material to be electrically connected to a second electrode and to the conductive liquid in the cavity, whereby a voltage can be applied to the first and second electrodes to influence a shape of the interface.

11. The method of claim 10, wherein:
the layer of material comprises a layer of silicon.

12. The method of claim 11, including:
depositing the first conductive material onto at least a portion of the top side of the layer of silicon;
depositing a first dielectric material over at least a portion of the first conductive material;
depositing a second dielectric material over at least a portion of the first dielectric material on the top side of the layer of silicon; and
wherein the first and second electrodes are positioned on the top side of the layer of silicon.

13. The method of claim 10, including:
forming an electrically conductive via extending through the layer of material, and wherein:
the second electrode is disposed on the bottom side of the layer of material.

14. The method of claim 13, wherein:
the first electrode is disposed on the bottom side of the layer of material.

15. A method of making a liquid lens having top-only electrical connections, the method comprising:
depositing a first conductive material onto a layer of material having a top side and a bottom side that is opposite the top side, and a recess, wherein the recess includes a conical side surface, wherein the conical side surface defines first and second circular edges forming top and bottom openings at the top and bottom sides, respectively, of the layer of material, whereby the first conductive material is deposited onto at least a portion of the conical side surface and at least a portion of the top side of the layer of material;
depositing a first dielectric material onto at least a portion of the first conductive material;
covering at least a portion of the first dielectric material on the conical side surface with an electrowetting material that is configured to provide an electrowetting interface with a conductive liquid;
electrically connecting a first electrode to the first conductive material;
depositing a second dielectric material onto at least a portion of the first dielectric material on the top side of the layer of material;
depositing a second conductive material onto at least a portion of the second dielectric material;
electrically connecting a second electrode to the second conductive material;
bonding a bottom layer of glass to the bottom side of the layer of material to close off the bottom opening of the recess;
depositing conductive and non-conductive liquids in the recess, an interface defined between the conductive and non-conductive liquids;
bonding a top layer of glass to the top side of the layer of material to close off the top opening of the recess to form a cavity, wherein at least a portion of the second conductive material is electrically connected to the cavity;
causing the second conductive material to be electrically connected to the conductive liquid in the cavity;
wherein the first and second electrodes are positioned on the top side of the layer of material, whereby a voltage can be applied to the first and second electrodes to influence a shape of the interface.

16. The method of claim 15, including:
bonding a temporary bottom layer onto the bottom side of the layer of material to close off the bottom opening;
followed by depositing the first conductive material onto a portion of the temporary bottom layer extending across the bottom opening.

17. The method of claim 15, including:
removing the temporary bottom layer prior to bonding the bottom layer of glass to the bottom side of the layer of material.

18. The method of claim 17, including:
cutting the first conductive material on the conical side surface around the bottom opening in the layer of material prior to removing the temporary bottom layer.

19. The method of claim 16, wherein:
the first conductive material deposited on the portion of the temporary bottom layer extending across the bottom opening is electrically connected to the first conductive material on the conical side surface; and including;
removing a portion of the first dielectric material on the top side of the layer of material to form exposed portions of the first conductive material;
electroplating a conductive material onto the exposed portions of the first conductive material utilizing an electrical connection to the first conductive material on the portion of the temporary bottom layer extending across the bottom opening.

20. The method of claim 19, wherein:
the second dielectric material is etch-selective whereby the second dielectric material can be selectively removed by etching without removing the first dielectric material; and including;
removing a portion of the second conductive material and the second dielectric material on the top side of the layer of material around the top opening utilizing an etching process.

21. The method of claim 20, wherein:
the electrowetting material is deposited onto the first dielectric material after the bottom layer of glass is bonded to the bottom side of the layer of material;
and wherein the electrowetting material is deposited onto the bottom layer of glass, the conical side surface of the layer of material extending around the top opening.

22. The method of claim 15, wherein:
the bottom layer of glass is bonded to the bottom side of the layer of material before the first dielectric material is deposited onto the first conductive material.
